(19) United States
(12) Patent Application Publication
(10) Pub. No.: US 2005/0036313 A1
(43) Pub. Date: Feb. 17, 2005

(54) Decorative light bulb

(76) Inventors: Ulrich Daucher, Paranaque (PH); Michael Hermann Schneck, Pasig City (PH)

Correspondence Address: SHOEMAKER AND MATTARE, LTD, 10 POST OFFICE ROAD - SUITE 110, SILVER SPRING, MD, 20910, US

(21) Appl. No.: 10/912,140

(22) Filed: Aug. 6, 2004

(30) Foreign Application Priority Data
Aug. 7, 2003 (PH) 2-2003-000306

(51) Int. Cl. F21V 17/04

(52) U.S. Cl. 362/255; 362/124; 362/806

(57) ABSTRACT

A decorative bulb has a bulb body formed to simulate desired shapes of an object, a base cap at the outer portion thereof and a filament at the inner portion thereof. The bulb body has desired corresponding surface ornamentations and colors and an ornate figure adhesively secured on an outer surface portion of the bulb body. The ornate figure is made from or any combination thereof of resin, glass, acrylic, silicone, plastic and glue materials.

### FIELD OF THE INVENTION

The present invention relates in general to light bulbs but more particularly to decorative light bulbs of different shapes and colors and provided with an ornate figure adhesively attached thereto.

### BACKGROUND OF THE INVENTION

Heretofore, most standard light bulbs are formed in standard geometrical shapes (cylindrical, circular rectangular or pear-shaped). Although standard light bulbs accomplish its intended purpose, experience dictates that if the shapes and colors could be modified in such a way as to provide aesthetic effect to the sense of sight and could be appropriately used to symbolize a particular occasion, such light bulbs could better serve its user.

### SUMMARY OF THE INVENTION

It is, therefore, the main object of the invention to provide for a decorative light bulb of different shapes and colors and provided with an ornate figure made from or any combination thereof of resin, glass, acrylic, silicone, plastic, and glue materials.

Another object of the present invention is to provide for a decorative light that is easy to install, maintain and is durable.

Still, another object of the present invention is to provide for a decorative light that is cheap and can easily be manufactured using local and readily available materials.

### BRIEF DESCRIPTION OF THE DIFFERENT VIEWS OF THE DRAWINGS

FIG. 1 is a perspective view showing a preferred embodiment of the decorative light bulb of the present invention;

FIG. 1a is a sectional view taken along line 1-1 of FIG. 1;

FIG. 2 is a perspective view of an embodiment thereof;

FIG. 3 is a perspective view of another embodiment thereof; and

FIG. 4 is a perspective view of another embodiment thereof.

### DETAILED DESCRIPTION

Referring now to the different views of the drawings, there is shown the present invention for a decorative light bulb designated as 10.

Decorative light bulb 10 comprises of a bulb body 11 formed to simulate desired shapes of an object and an ornate figure 12 adhesively secured on an outer surface portion “P” of said bulb body 11. Light bulb 10 is removably connected to an electrical source at a predetermined location and then switched-on a normal bulb (not shown). Light bulb 10 can also be installed and arranged in series or parallel or in any desired configuration.

As shown in the drawings, bulb body 11 is provided with a base cap 13 at the outer portion, preferably on one end portion thereof, and a filament at the inner portion thereof. Bulb body 11 is further provided with the desired colors and corresponding surface ornamentations 14.

Ornate figure 12 is made from or any combination thereof of resin, glass, acrylic, silicone, plastic and glue materials. In a preferred embodiment of the present invention as further shown in the drawings, ornate figure 12 simulates the appearance of the head portion of a military cadet “M”. And the corresponding surface ornamentation 14 on the bulb body 11 simulates the appearance of the cadet's uniform.

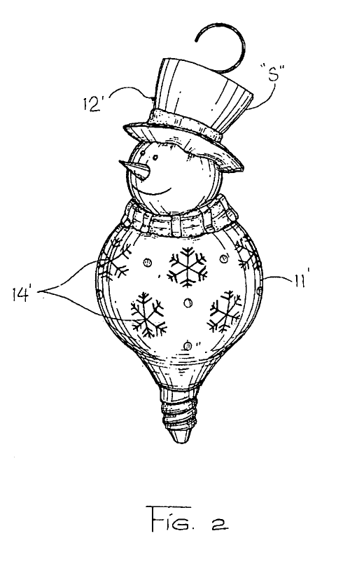

In another embodiment of the present invention as shown in FIG. 2, ornate figure 12′ simulates the appearance of the head portion of a snowman “S”. And the corresponding surface ornamentation 14′ on the bulb body 11′ simulates Christmas light glitters.

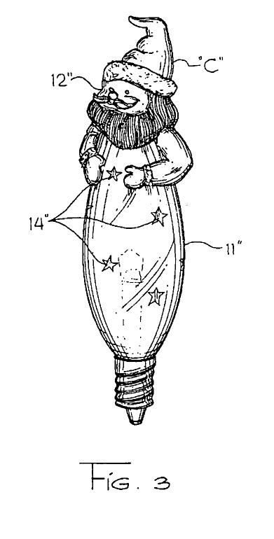

In another embodiment of the present invention as shown in FIG. 3, ornate figure 12″ simulates the appearance of the head portion of a Santa Claus “C”. The surface ornamentation 14″ on the bulb body 11″ simulates star figures.

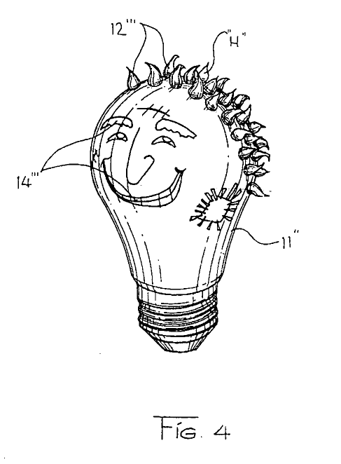

Still, in another embodiment of the present invention as shown in FIG. 4, ornate figure 12′″ simulates the appearance of a plurality of hair strands “H”. The surface ornamentation 14′″ on the bulb body 11′″ simulates the face of a person.

The shapes of bulb body 11 are not limited to the embodiments presented herein but may also comprise shapes of characters like a teddy bear, Santa Claus, Easter bunny, angel, Halloween ghosts, a heart, fruits, vegetables, cars, animals, cartoon characters, spaceships, rockets, flowers, and any non-descript form.

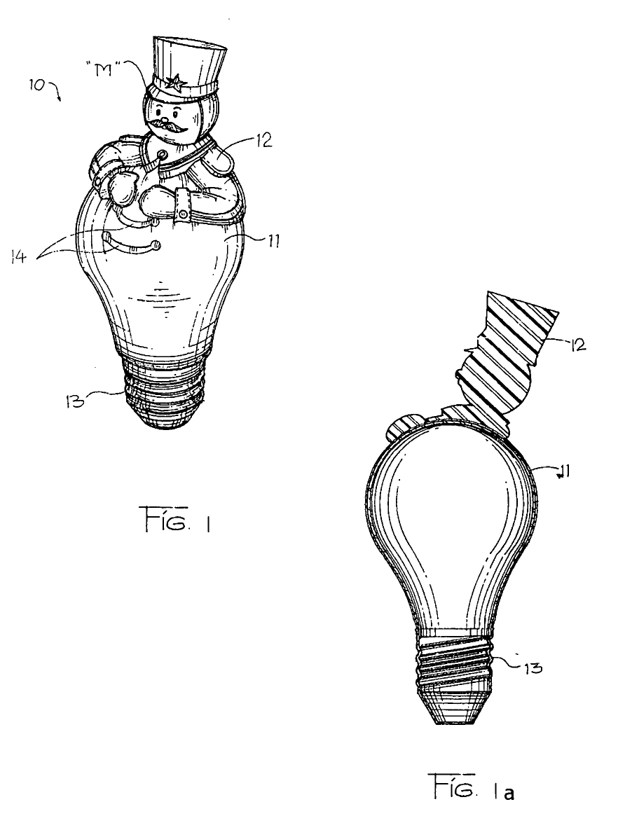

FIG. 1a is a sectional view of the preferred embodiment of the present invention. FIG. 1a shows the ornate figure being made of a different material or a combination of the aforesaid materials and the bulb body basically made of glass which is further painted with the desired colors and corresponding surface ornamentations.

1. A decorative light bulb comprising;
a bulb body formed to simulate desired shapes of an object being provided with a base cap at the outer portion thereof and a filament at the inner portion thereof, said bulb body being further provided with desired corresponding surface ornamentations and colors; and
an ornate figure being adhesively secured on an outer surface portion of said bulb body, said ornate figure being made from or any combination thereof of resin, glass, acrylic, silicone, plastic and glue materials.

2. A decorative light bulb in accordance with claim 1 wherein, said ornate figure simulates the appearance of the head portion of a snowman.

3. A decorative light bulb in accordance with claim 1 wherein, said ornate figure simulates the appearance of the head portion of a military cadet.

4. A decorative light bulb in accordance with claim 1 wherein, said ornate figure simulates the appearance of the head portion of Santa Claus.

5. A decorative light bulb in accordance with claim 1 wherein, said ornate figure simulates the appearance of a plurality of hair strands.

6. A decorative light bulb in accordance with claim 1 wherein, the shapes of said bulb body comprise characters like a teddy bear, Santa Claus, Easter bunny, angel, Halloween ghosts, a heart, fruits, vegetables, cars, animals, cartoon characters, spaceships, rockets, flowers and the like.
